(19) United States
(12) Patent Application Publication
(10) Pub. No.: US 2026/0085732 A1
(43) Pub. Date: Mar. 26, 2026

(54) BRAKE ASSEMBLY ABUTMENT CLIP WITH INCLINED PAD LOADING LEG

(71) Applicant: HL MANDO CORPORATION, Gyeonggi-do (KR)

(72) Inventor: Satish KOLEKAR, Novi, MI (US)

(21) Appl. No.: 19/268,286

(22) Filed: Jul. 14, 2025

Related U.S. Application Data
(60) Provisional application No. 63/697,095, filed on Sep. 20, 2024.

(51) Int. Cl. F16D 65/097; B60T 13/74; F16D 55/226; F16D 65/18; F16D 121/24; F16D 127/02

(52) U.S. Cl. CPC F16D 65/0972; B60T 13/746; F16D 55/2262; B60T 2270/82; F16D 65/18; F16D 2121/24; F16D 2127/02; F16D 2200/0021

(57) ABSTRACT

A brake assembly is provided. The brake assembly includes: a brake rotor configured to be rotatable with a wheel of a vehicle; a brake pad assembly configured to be engageable with the brake rotor; an actuator assembly having an electric motor configured to mechanically move the brake pad assembly toward or away from the brake rotor; and an abutment clip. The abutment clip includes: a first holding portion configured to hold the abutment clip against a caliper; and a second holding portion configured to hold a brake pad of the brake pad assembly, the second holding portion having an inclined loading leg.

### CROSS REFERENCE TO PARENT APPLICATIONS

This application claims the benefit of U.S. Patent Application Ser. No. 63/697,095 filed on Sep. 20, 2024, entitled “ABUTMENT CLIP WITH INCLINED BRAKE PAD LOADING LEG”, the entirety of which is incorporated herein by reference.

### BACKGROUND

Various embodiments of the present disclosure generally relate to a brake assembly and more particularly to a brake assembly abutment clip.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” electromechanical brake (EMB) systems, and electric or “brake by wire.”

For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

Electric brake systems may also include an electric motor that controls movement of the electric actuator and sensors for measuring a position of the electric motor.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, a brake assembly may comprise: a brake rotor configured to be rotatable with a wheel of a vehicle; a brake pad assembly configured to be engageable with the brake rotor; an actuator assembly comprising an electric motor configured to mechanically move the brake pad assembly toward or away from the brake rotor; and an abutment clip. The abutment clip may comprise: a first holding portion configured to hold the abutment clip against a caliper; and a second holding portion configured to hold a brake pad of the brake pad assembly, the second holding portion comprising an inclined loading leg.

The inclined loading leg is lower at a first side of the abutment clip that farther away from the brake rotor and higher at a second side of the abutment clip that is closer to the brake rotor.

The inclined loading leg comprises a tail portion that engages with the brake pad and the tail portion of the inclined loading leg is inclined.

The tail portion of the inclined loading leg is inclined at an angle of at least 5 to 50 degrees.

The inclined loading leg is configured to be displaceable from an original position of the inclined loading leg by the brake pad as the brake pad presses against the inclined loading leg when the brake pad assembly is moved, by the electric motor, toward the brake rotor.

The inclined loading leg of the abutment clip is configured to, when the inclined loading leg is displaced by the brake pad after the electric motor stops moving the brake pad, return to the original position and, while returning to the original position, push the brake pad away from the brake rotor.

The inclined loading leg of the abutment clip is configured to push away the brake pad from the brake rotor to a position within the brake assembly where the brake pad is in a drag-less state during a non-braking operation of the vehicle.

The brake assembly is an electromechanical brake (EMB) system.

The brake assembly is a brake by wire-based brake system.

The abutment clip is made of flexible stainless steel.

According to various embodiments of the present disclosure, an abutment clip for a brake assembly may comprise: a first holding portion configured to hold the abutment clip against a caliper of the brake assembly; and a second holding portion configured to hold a brake pad of a brake pad assembly of the second holding portion comprising an inclined loading leg.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of a brake assembly according to one or more exemplary embodiments of the present disclosure.

FIG. 2A shows a front view of an abutment clip according to one or more exemplary embodiments of the present disclosure.

FIG. 2B shows a side view of an abutment clip according to one or more exemplary embodiments of the present disclosure.

FIGS. 3A and 3B show implementation examples according to one or more exemplary embodiments of the present disclosure.

FIG. 4 shows a schematic view of a vehicle including a steering system and a brake assembly according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

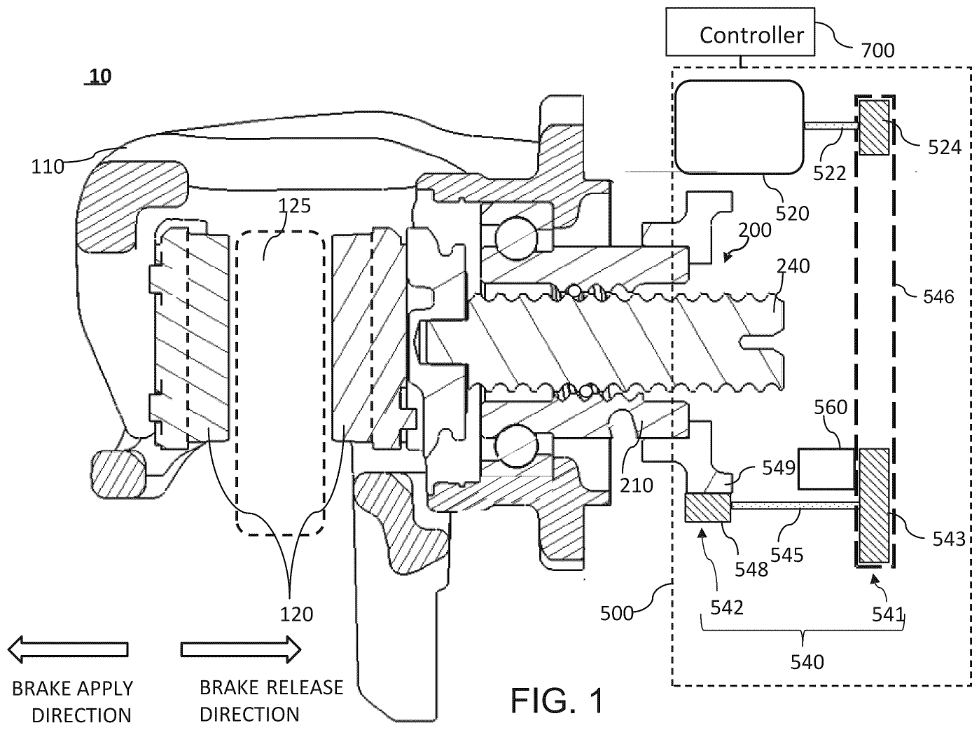

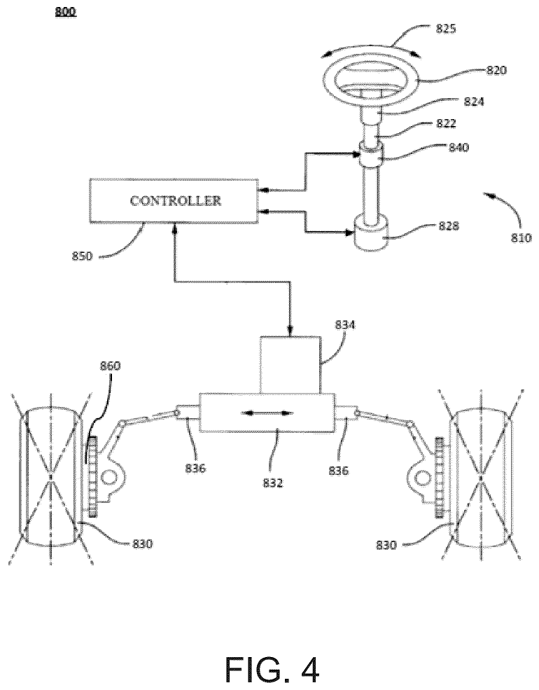

A vehicle (see, e.g., FIG. 4) may be equipped with one or more brake systems (e.g., an EMB system, a hydraulic system, an anti-lock or “ABS” system, an electric or “brake by wire” system, or the like) for slowing down or stopping rotation of a wheel of the vehicle (e.g., providing braking and stopping capabilities for vehicle). Such brake systems are usually equipped with abutment clips for guiding brake pads (e.g., 120, FIG. 1) towards a brake rotor (e.g., 125, FIG. 1). Such abutment clips may be configured to move the brake pads away from the brake rotor once braking operations have stopped to prevent occurrence of drag between the brake pads and the brake rotor. In particular, drag not only causes increased, faster wear on the brake pads and brake rotor but also causes less efficient battery life for the vehicle's battery. More specifically, dragging brake calipers (e.g., where contact between the brake pads and the brake rotor still exist when braking operations are not required during regular driving operations) contributes to the reduced efficiency of vehicle battery life where approximately 0.5 mile loss per 1 Nm of drag from the brake caliper is experienced. Thus, unconventional solutions for reducing the possibility of dragging brake calipers are constantly being sought out.

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 (e.g., an electromechanical brake (EMB) system, or the like) is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatable part 210. Alternatively, the electric motor 520 is indirectly connected to the rotatable part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable part 210 of the drive mechanism 540. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the electric motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of a rotatable body or nut of rotatable part 210 of the drive mechanism 540 or screw mechanism 200 or be mounted to the rotatable body of rotatable part 210 of the drive mechanism 540 to rotate the rotatable body or nut of rotatable part 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assembly 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake 560 is applied, the displacement of the brake pad assembly 120 in the brake release direction can cause the rotor of the electric motor 520 (e.g., the motor shaft 522) to rotate due to the mechanical connection between the electric motor 520 and the brake pad assembly 120. As a result, a position of the electric motor 520 can be used to determine a linear position of the brake pad assembly 120, and vice versa.

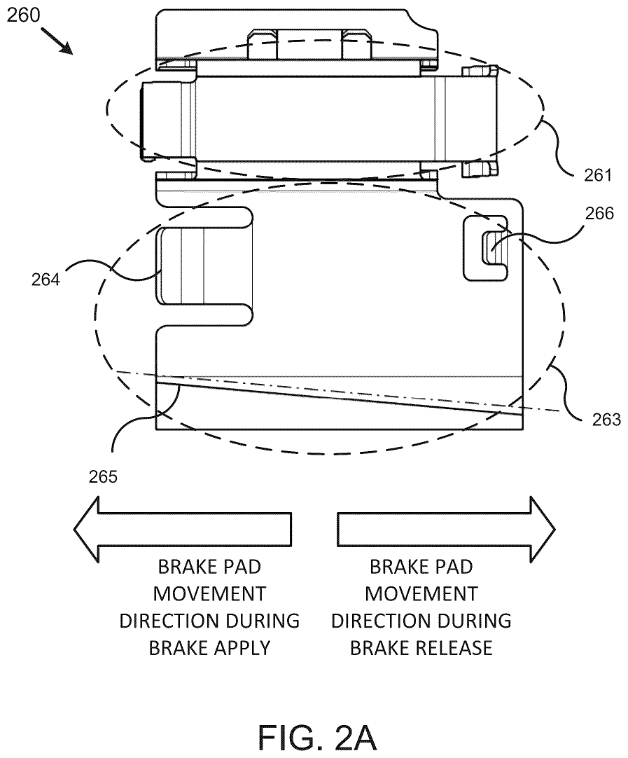

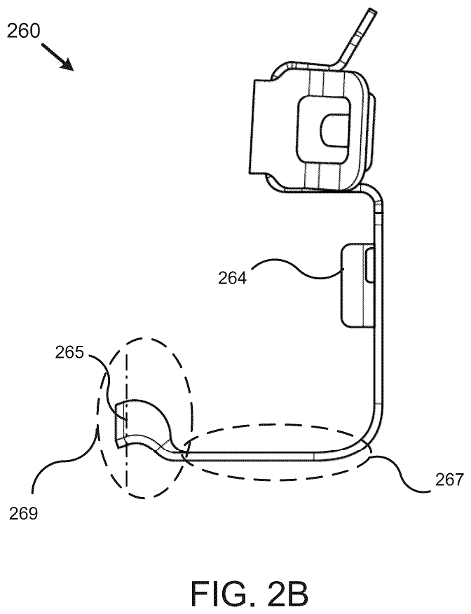

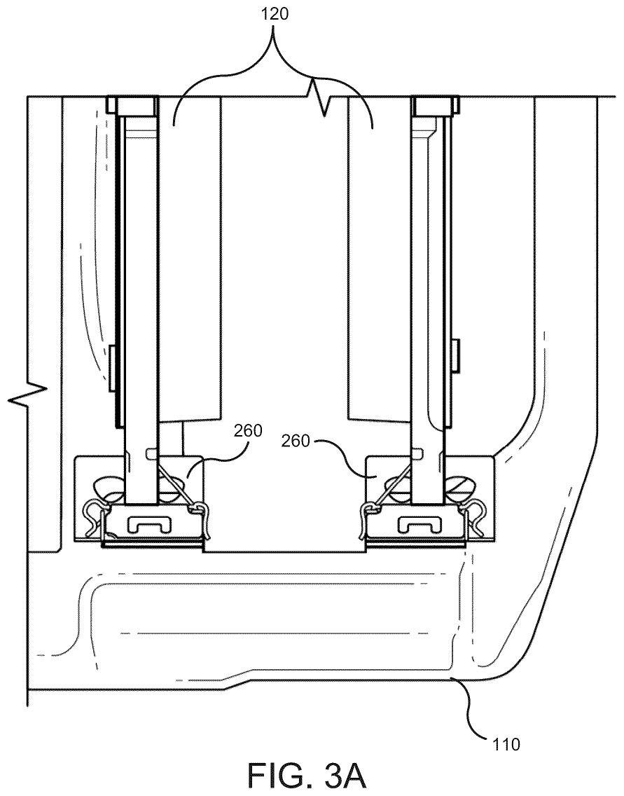

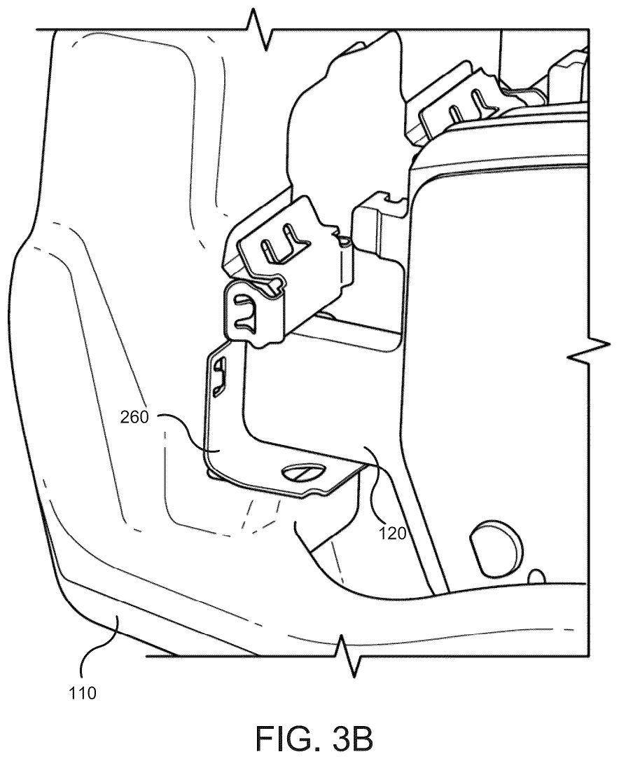

To detect such changes in the linear position of the brake pad assembly 120, brake assembly 10 may further include a controller 700 that is able to measure a movement and/or position of the electric motor 520 (e.g., via one or more sensors not shown in FIG. 1) and a torque (e.g., motor torque) generated by the electric motor 520. The controller 700 may also be configured to control the electric motor 520 to perform braking operations of the brake assembly 10 (e.g., the above discussed movement of the translatable part 240 to cause the brake pad assembly 120 to engage with the brake rotor 125). One example of the sensors configured to be installed within the brake assembly 10 may be the inductive position sensor of embodiments disclosed herein that is described in more detail in reference to FIGS. 2A-3B.

These one or more sensors may include any type and combination of sensors including, but not limited to: (i) force sensors, (ii) motor angle sensors; (iii) linear position sensors; (iv) temperature sensors; (v) current sensors; (iv) torque sensors; or the like. These one or more sensors may also be disposed (e.g., installed) within any portion of the brake assembly that is in proximity of the component or components that the sensors are configured to monitor and from which the sensors are configured to obtain measurements (e.g., obtain sensor readings from).

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components. The controller 700 may be coupled to (e.g., one or more components of) the actuator assembly.

Although FIG. 1 is shown using an EMB system as an example for the brake assembly 10, embodiments disclosed herein are not limited to such a configuration. In particular, the brake assembly 10 may be associated with any type of brake system (e.g., an EMB system, a hydraulic system, an anti-lock or “ABS” system, an electric or “brake by wire” system, or the like).

FIG. 2A shows a front view of an abutment clip 260 according to one or more exemplary embodiments of the present disclosure while FIG. 2B shows a side view of the abutment clip 260.

In embodiments, abutment clip 260 may be a brake pad abutment clip that is configured to guide and hold the brake pads of the brake pad assembly 120 within a housing of the brake caliper 110. Additional details showing how the abutment clip 260 is installed within brake assembly 10 is shown in FIGS. 3A and 3B.

Abutment clip 260 may include a first holding portion 261 that is configured to be attached onto an internal surface of the brake caliper 110. The first holding portion 261 may include any number of attachment members, grooves, and/or other mechanical components (e.g., nuts and bolts, rivets, or the like) that allow for secure attachment of the abutment clip 260 to an internal surface of the brake caliper 110 (e.g., as shown in FIGS. 3A and 3B discussed in more detail below).

In this example of embodiments disclosed herein, the first holding portion 261 is configured to be form fitting with a protrusion included on the internal surface of the brake caliper 110 such that the first holding portion 261 is able to latch onto the protrusion when the first holding portion 261 of abutment clip 260 is fitted into the protrusion.

However, the shape and configuration of the first holding portion 261 is not limited to such a design as shown in FIGS. 2A and 2B and may include any shape, form, configuration, and/or components that would allow the abutment clip 260 to be securely attached to an internal surface of the housing of the brake caliper 110.

Abutment clip 260 may also include a second holding portion 263. This second holding portion 263 may be directly attached to the first holding portion 261. In embodiments, the abutment clip 260 may be configured as a monolithic structure made of, for example, but not limited to: flexible stainless steel, a polymeric-based and/or polymer-based material, or the like.

Although FIGS. 2A and 2B show the second holding portion 263 being positioned under the first holding portion 261, embodiments disclosed herein are limited to this configuration. For example, based on the design of the brake caliper housing and the placement of the brake pads of the brake pad assembly 120 within the brake caliper housing, the second holding portion 263 may also be positioned on top or towards either side of the first holding portion 261 without departing from embodiments disclosed herein.

As shown from the side view of FIG. 2B, the second holding portion 263 may include a groove (e.g., an indentation, opening, or the like) for receiving and holding a portion of the brake pads of the brake pad assembly 120. For example, each brake pad of the brake pad assembly 120 may include a protrusion, a tab, or the like that is configured to be installed into and held within the groove of the second holding portion 263.

The groove of the second holding portion 263 may be formed to include a loading leg having a base portion 267 and a tail portion 269. In embodiments, the base portion 267 may extend outwards at a distance that corresponds to a size and shape of the protrusion, tab, and/or other mechanical structure of the brake pads that is configured to be held within second holding portion 263.

The tail portion 269 of the loading leg may extend upwards from a terminal end of the base portion 267 and be configured to receive a bottom of the protrusion, tab, and/or other mechanical structure of the brake pads. This allows the protrusion, tab, and/or other mechanical structure of the brake pads inserted into the second holding portion 263 to be securely held and guided within the second holding portion 263 as the brake pad assembly 120 is actuated during braking operations of the vehicle.

As shown in FIGS. 2A and 2B, in embodiments, the terminal end of tail portion 269 that contacts the mechanical structure of each of the brake pads of the brake pad assembly 120 is configured to be inclined. This incline 265 (also referred to herein as “incline portion” or “inclined portion”) on the tail portion 269 increases from one end of the tail portion 269 towards the other end of the tail portion 269.

This incline 265 on the tail portion 269 is higher at a position where the brake pads of the brake pad assembly 120 contact the brake rotor 125. As a result, the brake pads of the brake pad assembly 120 will experience more resistance as they are moved toward the brake rotor 125 during a braking operation of the vehicle. With this incline 265, the loading leg of the abutment clip 260 may also be referred to herein as an “inclined loading leg.”

In embodiments the inclined loading leg may have an incline 265 (i.e., at/on the tail portion 269) of greater than 0 degrees but less than or equal to 30 degrees. This range of greater than 0 degrees but less than or equal to 30 degrees directly contributes to a criticality of embodiments disclosed herein by providing the required incline for the tail portion 269 of the abutment clip 260 to independently (i.e., without the help of other additional forces beside the force asserted by the brake pads on the tail portion 269 as the brake pads travel toward the brake rotor 125 in the brake apply direction) push the brake pads of the brake assembly 120 back in the brake release direction to prevent an occurrence of drag between the brake pads and the brake rotor 125. This incline 265 and the angle at which the incline 265 is inclined also solves a long felt need in brake technology where brake systems are not provided with a non-electrical, self-propulsion mechanism for pushing the brake pads away from the brake rotor 125 after a braking operation has ended.

Additionally, this range of greater than 0 degrees but less than or equal to 30 degrees takes into consideration that the angle cannot be too large such that negative effects to the brake pad assembly 120 and/or other components of the brake assembly 10 start occurring. For example, an incline angle that is too large (e.g., larger than 30 degrees) may cause increased pinch force of the brake pad assembly 120 as the brake pad assembly 120 moves towards the brake rotor 125 due to wear and tear of the brake pads of the brake pad assembly 120. Additionally, the increased pinch force could also negatively impact structures of the brake assembly 10 such as the backplate ears (not shown) (e.g., when a notch on the backplate is created due to normal wear and tear conditions, locking of this notch with the abutment clip 260 may lead to movement of the abutment clip 260 from the bracket, resulting in uneven loading and even cracks in the bracket and abutment clip). Additionally, although a larger angle could more effectively move the brake pads of the brake pad assembly 120 away from the brake rotor 125, the larger angle will also negatively increase a fluid displacement in a caliper (not shown) of the brake assembly 10 (e.g., over a maximum fluid displacement limit of the caliper or the like) when the brakes are being applied during operation of the vehicle.

Additionally, the combination of the inclined loading leg and the mechanical properties (e.g., flexibility, or the like) of the material making up the abutment clip 260 allows the abutment clip 260 to automatically (e.g., without needing other external forces) be able to push the brake pad installed within the abutment clip 260 away from the brake rotor 125 once braking operations are over.

More specifically, the mechanical properties (e.g., flexibility, or the like) of the material making up the abutment clip 260 causes the inclined loading leg (when the inclined loading leg is pressed down by the brake pad) to push back against the brake pad in order for the inclined loading leg to return to its original shape before being pushed down by the brake pad. Thus, after braking operations are over and the electric motor 520 is no longer pushing (e.g., actuating) the brake pads of the brake bad assembly 120 towards the brake rotor 125, the inclined loading leg of the abutment clip 260 will be able to push the brake pads of the brake bad assembly 120 away from the brake rotor 125 to create enough clearance between the brake pads of the brake bad assembly 120 and the brake rotor 125 to eliminate any possible of drag between these two components (e.g., to place the brake pads of the brake bad assembly 120 away from the brake rotor 125 in a drag-less state).

In some embodiments, only a portion of the inclined loading leg may have the incline 265. For example, part of the inclined loading leg may be flat (i.e., at 0 degrees with no incline at all) while another part of the inclined loading leg may include the incline 265. In such an embodiment, the maximum angle of the incline 265 of the inclined portion of the inclined loading leg may be less than or equal to 65 degrees. Additionally, the portion of the inclined loading leg that is flat may have a size that is larger than a surface of the brake pad (of the brake pad assembly 120) that is to be seated onto the flat portion of the inclined loading leg.

In embodiments, the second holding portion 263 may also include a retraction arm 264 and a stopper 266. The retraction arm 264 may be disposed on a side of the abutment clip 260 that is closer to the brake rotor 125. As shown in FIG. 3A, the brake pads of the brake pad assembly 120 will push against and displace the retraction arm 264 from its original position. Similar to the inclined loading leg, the mechanical properties (e.g., flexibility, or the like) of the material making up the retraction arm 264 of the abutment clip 260 will cause the retraction arm 264 to push the brake pads of the brake pad assembly 120 away from the brake rotor 125 as the retraction arm 264 automatically returns to its original position (namely, once any external force(s) pushing the brake pads of the brake pad assembly 120 against the retraction arm 264 disappears and/or stops).

The stopper 266 may be configured as a mechanical structure that protrudes outward into the groove formed by the second holding portion 263 and may be configured to stop the brake pad (of the brake pad assembly 120) that is installed (e.g., held and guided) within the second holding portion 263 from falling out of the second holding portion 263 of the abutment clip 260.

FIGS. 3A and 3B show implementation examples where the abutment clip 260 of FIGS. 2A and 2B are installed within a housing of brake caliper 110 of brake assembly 10.

As shown in FIGS. 3A and 3B, each brake assembly 10 may include at least four (4) of the abutment clips 260 (e.g., the two shown in FIGS. 3A and 3B and two more across from the two shown in FIGS. 3A and 3B). Each of the four abutment clips 260 may be configured to be installed on (e.g., attached to via the first holding portion 261 of each abutment clip 260) an internal surface of the brake caliper 110 housing.

Each of the four abutment clips 260 may also be configured to receive, hold, and guide (e.g., within second holding portion 263) the brake pads (e.g., via holding a mechanical structure of one or more brake pad holders of the brake pads or the like) of the brake pad assembly 120.

As shown in FIGS. 3A and 3B, a portion (e.g., an abutment, protrusion, leg, arm, or the like) of each of the brake pads of the brake pad assembly 120 is inserted within the second holding portion 263 of the abutment clips 260. This advantageously allows the brake pads of the brake pad assembly 120 to be guided in a more secured manner as the brake pads of the brake pad assembly 120 are actuated toward the brake rotor 125.

Additionally, once the external force(s) pushing the brake pads of the brake pad assembly 120 towards the brake rotor 125 disappears, the inclined loading leg of the abutment clips 260 (in addition to the retraction arm 264 of the abutment clips 260) may advantageously push (e.g., without needing any help from the electrical motor, and also without needing any electrical power at all to be supplied to the components of the brake caliper 110/brake assembly 10) the brake pads of the brake pad assembly 120 away from the brake rotor 125 to create a clearance between the brake pads of the brake pad assembly 120 away from the brake rotor 125 such that drag between the brake pads of the brake pad assembly 120 away from the brake rotor 125 can be advantageously eliminated.

Any vehicle according to certain exemplary embodiments of the present disclosure may be identical, or substantially similar to, vehicle 800 shown in FIG. 4. The vehicle 800 may be any passenger or commercial automobile such as a hybrid vehicle, an electric vehicle, or any other type vehicles. FIG. 4 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor which is connected to the steering shaft or steering column 822. The feedback actuator or steering feel actuator 828 provides the driver or operator with the same “road feel” that the driver receives with a direct mechanical link.

Although the embodiment illustrated in FIG. 4 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A brake assembly comprising:
a brake rotor configured to be rotatable with a wheel of a vehicle;
a brake pad assembly configured to be engageable with the brake rotor;
an actuator assembly comprising an electric motor configured to mechanically move the brake pad assembly toward or away from the brake rotor; and
an abutment clip comprising:
a first holding portion configured to hold the abutment clip against a caliper; and
a second holding portion configured to hold a brake pad of the brake pad assembly, the second holding portion comprising an inclined loading leg.

2. The brake assembly of claim 1, wherein the inclined loading leg is lower at a first side of the abutment clip that farther away from the brake rotor and higher at a second side of the abutment clip that is closer to the brake rotor.

3. The brake assembly of claim 2, wherein the inclined loading leg comprises a tail portion that engages with the brake pad and the tail portion of the inclined loading leg is inclined.

4. The brake assembly of claim 3, wherein the tail portion of the inclined loading leg is inclined at an angle of greater than 0 degrees but less than or equal to 30 degrees.

5. The brake assembly of claim 2, wherein the inclined loading leg is configured to be displaceable from an original position of the inclined loading leg by the brake pad as the brake pad presses against the inclined loading leg when the brake pad assembly is moved, by the electric motor, toward the brake rotor.

6. The brake assembly of claim 5, wherein the inclined loading leg of the abutment clip is configured to, when the inclined loading leg is displaced by the brake pad after the electric motor stops moving the brake pad, return to the original position and, while returning to the original position, push the brake pad away from the brake rotor.

7. The brake assembly of claim 6, wherein the inclined loading leg of the abutment clip is configured to push away the brake pad from the brake rotor to a position within the brake assembly where the brake pad is in a drag-less state during a non-braking operation of the vehicle.

8. The brake assembly of claim 6, wherein the brake assembly is an electromechanical brake (EMB) system.

9. The brake assembly of claim 6, wherein the brake assembly is a brake by wire-based brake system.

10. The brake assembly of claim 6, wherein the abutment clip is made of flexible stainless steel.

11. An abutment clip of a brake assembly comprising:
a first holding portion configured to hold the abutment clip against a caliper of the brake assembly; and
a second holding portion configured to hold a brake pad of a brake pad assembly of the second holding portion comprising an inclined loading leg.

12. The abutment clip of claim 11, wherein the inclined loading leg is lower at a first side of the abutment clip that farther away from a brake rotor, configured to be rotatable with a wheel of a vehicle, and higher at a second side of the abutment clip that is closer to the brake rotor.

13. The abutment clip of claim 12, wherein the inclined loading leg comprises a tail portion that engages with the brake pad and the tail portion of the inclined loading leg is inclined.

14. The abutment clip of claim 13, wherein the tail portion of the inclined loading leg is inclined at an angle of greater than 0 degrees but less than or equal to 30 degrees.

15. The abutment clip of claim 13, wherein the inclined loading leg is configured to be displaceable from an original position of the inclined loading leg by the brake pad as the brake pad presses against the inclined loading leg when the brake pad assembly is moved, by the electric motor, toward the brake rotor.

16. The abutment clip of claim 15, wherein the inclined loading leg of the abutment clip is configured to, when the inclined loading leg is displaced by the brake pad after the electric motor stops moving the brake pad, return to the original position and, while returning to the original position, push the brake pad away from the brake rotor.

17. The abutment clip of claim 16, wherein the inclined loading leg of the abutment clip is configured to push away the brake pad from the brake rotor to a position within the brake assembly where the brake pad is in a drag-less state during a non-braking operation of a vehicle.

18. The abutment clip of claim 17, wherein the brake assembly is an electromechanical brake (EMB) system.

19. The abutment clip of claim 17, wherein the brake assembly is a brake by wire-based brake system.

20. The abutment clip of claim 17, wherein the abutment clip is made of flexible stainless steel.
